(19) United States
(12) Patent Application Publication
(10) Pub. No.: US 2025/0227439 A1
(43) Pub. Date: Jul. 10, 2025

(54) METHOD AND APPARATUS FOR PROCESSING SENSING SERVICE, COMMUNICATION DEVICE AND STORAGE MEDIUM

(71) Applicant: Beijing Xiaomi Mobile Software Co., Ltd., Beijing (CN)

(72) Inventor: Yang SHEN, Beijing (CN)

(73) Assignee: Beijing Xiaomi Mobile Software Co., Ltd., Beijing (CN)

(21) Appl. No.: 18/849,426

(22) PCT Filed: Mar. 22, 2022
(86) PCT No.: PCT/CN2022/082360

§ 371 Date: Sep. 20, 2024

(51) Int. Cl. H04W 4/38

(52) U.S. Cl. CPC H04W 4/38

(57) ABSTRACT

A method, apparatus and computer readable medium for processing a sensing service, performed by a first network element. The processing is performed by: determining a candidate mode for processing sensing data from at least one source; where the candidate mode is determined from at least one predetermined sensing data processing mode.

### CROSS-REFERENCE TO RELATED APPLICATION

The present application is a U.S. National Stage of International Application No. PCT/CN2022/082360, filed on Mar. 22, 2022, the contents of which are incorporated herein by reference in their entirety.

### TECHNICAL FIELD

The present disclosure relates to, but is not limited to, the field of wireless communication technologies, and in particular to methods and apparatuses for processing a sensing service, communication devices and storage media.

### BACKGROUND

Wireless sensing technologies are designed to acquire information about remote objects and their characteristics without the need for physical contact. In this way, it is possible to utilize sensing data of the object and its surroundings for analysis to obtain meaningful information specific to the object and its characteristics. For example, sensing data processing may combine sensing data from at least one source to obtain a sensing result, such that the sensing result has less uncertainty than would be possible when these sources were used individually.

In related technologies, a wireless sensing technology can cooperate with a wireless network, and how to realize the cooperation between them is a problem that needs to be considered.

### SUMMARY

Embodiments of the present disclosure provide methods and apparatuses for processing a sensing service, communication devices, and storage media.

According to a first aspect of an embodiment of the present disclosure, a method for processing a serving service is provided, performed by a first network element and including: determining a candidate mode for processing sensing data from at least one source;
where the candidate mode is determined from at least one predetermined sensing data processing mode.

According to a second aspect of an embodiment of the present disclosure, a method for processing a serving service is provided, performed by a terminal and including:
sending sensing service request information to a first network element;
where the sensing service request information is used for the first network element to determine a candidate mode, which is for processing sensing data from at least one source, from at least one predetermined sensing data processing mode.

According to a third aspect of an embodiment of the present disclosure, a method for processing a serving service is provided, performed by a fourth network element and including:
sending sensing service request information to a first network element;
where the sensing service request information is used for the first network element to determine a candidate mode, which is for processing sensing data from at least one source, from at least one predetermined sensing data processing mode.

### BRIEF DESCRIPTION OF DRAWINGS

FIG. 1 is a schematic structural diagram of a wireless communication system according to an embodiment of the present disclosure.

FIG. 2 is a schematic diagram of processing a sensing data according to an embodiment of the present disclosure.

FIG. 3 is a schematic diagram of processing a sensing data according to an embodiment of the present disclosure.

FIG. 4 is a schematic diagram of processing a sensing data according to an embodiment of the present disclosure.

FIG. 5 is a schematic diagram of processing a sensing data according to an embodiment of the present disclosure.

FIG. 6 is a schematic diagram of processing a sensing data according to an embodiment of the present disclosure.

FIG. 7 is a schematic diagram of processing a sensing data according to an embodiment of the present disclosure.

FIG. 8 is a schematic diagram of processing a sensing data according to an embodiment of the present disclosure.

FIG. 9 is a schematic diagram of processing a sensing data according to an embodiment of the present disclosure.

FIG. 10 is a schematic diagram of processing a sensing data according to an embodiment of the present disclosure.

FIG. 11 is a schematic diagram of processing a sensing data according to an embodiment of the present disclosure.

FIG. 12 is a schematic diagram of processing a sensing data according to an embodiment of the present disclosure.

FIG. 13 is a flowchart of a method for processing a sensing service according to an embodiment of the present disclosure.

FIG. 14 is a flowchart of a method for processing a sensing service according to an embodiment of the present disclosure.

FIG. 15 is a flowchart of a method for processing a sensing service according to an embodiment of the present disclosure.

FIG. 16 is a flowchart of a method for processing a sensing service according to an embodiment of the present disclosure.

FIG. 17 is a flowchart of a method for processing a sensing service according to an embodiment of the present disclosure.

FIG. 18 is a flowchart of a method for processing a sensing service according to an embodiment of the present disclosure.

FIG. 19 is a flowchart of a method for processing a sensing service according to an embodiment of the present disclosure.

FIG. 20 is a flowchart of a method for processing a sensing service according to an embodiment of the present disclosure.

FIG. 21 is a flowchart of a method for processing a sensing service according to an embodiment of the present disclosure.

FIG. 22 is a flowchart of a method for processing a sensing service according to an embodiment of the present disclosure.

FIG. 23 is a schematic structural diagram of an apparatus for processing a sensing service according to an embodiment of the present disclosure.

FIG. 24 is a schematic structural diagram of an apparatus for processing a sensing service according to an embodiment of the present disclosure.

FIG. 25 is a flowchart of a method for processing a sensing service according to an embodiment of the present disclosure.

FIG. 26 is a flowchart of a method for processing a sensing service according to an embodiment of the present disclosure.

FIG. 27 is a flowchart of a method for processing a sensing service according to an embodiment of the present disclosure.

FIG. 28 is a schematic structural diagram of a terminal according to an embodiment of the present disclosure.

FIG. 29 is a block diagram of a base station according to an embodiment of the present disclosure.

### DETAILED DESCRIPTION

Reference will now be made in detail to embodiments of the present disclosure, examples of which are illustrated in the accompanying drawings. When the following description refers to the accompanying drawings, unless otherwise indicated, the same numbers in different accompanying drawings indicate the same or similar elements. Implementations described in the following embodiments of the present disclosure do not represent all implementations consistent with the embodiments of the present disclosure. Rather, they are merely examples of apparatuses and methods consistent with some aspects of embodiments of the present disclosure as detailed in the appended claims.

Terms used in embodiments of the present disclosure are only for a purpose of describing specific embodiments, and are not limiting the embodiments of the present disclosure. Singular forms of “a,” said,” and “the” used in the embodiments of the present disclosure and in the claims are also intended to include majority forms, unless the context clearly indicates otherwise. It should also be understood that the term “and/or” as used herein refers to any or all of the possible combinations containing one or more of the listed items in association.

It should be understood that although terms first, second, third, etc. may be used to describe various information in the embodiments of the present disclosure, this information should not be limited to these terms. These terms are used only to distinguish the same type of information from one another. For example, without departing from the scope of the present disclosure, first information can also be named as second information, and similarly, the second information can also be named as the first information. Depending on the context, the word “if” as used herein can be interpreted as “at,” “when,” or “in response to determining”.

For the purpose of simplicity and ease of understanding, the terms used in the present disclosure to represent size relationships are “greater than” or “less than”. But for those skilled in the art, it can be understood that the term “greater than” also covers the meaning of “greater than or equal to” and “less than” also covers the meaning of “less than or equal to”.

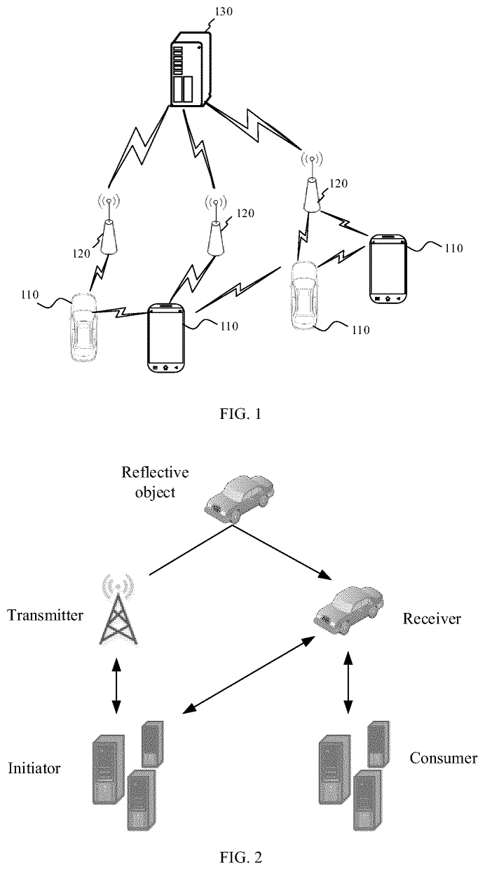

Please refer to FIG. 1, which shows a schematic structural diagram of a wireless communication system according to an embodiment of the present disclosure. As shown in FIG. 1, the wireless communication system is a communication system based on mobile communication technology, which may include several user equipments 110 and several base stations 120.

A user equipment 110 may be a device that provides voice and/or data connectivity to users. The user equipment 110 can communicate with one or more core networks via a radio access network (RAN). The user equipment 110 can be an Internet of Things user equipment, such as a sensor device, a mobile phone and a computer with an Internet of Things user equipment. For example, it can be a fixed, portable, pocket-sized, handheld, computer-built or vehicle-mounted device. For example, a station (STA), a subscriber unit, a subscriber station, a mobile station, a mobile, a remote station, an access point, a remote terminal, an access terminal, a user terminal, a user agent, a user device, or a user equipment. Or, the user equipment 110 can also be a device for an unmanned aerial vehicle. Or, the user equipment 110 can also be a vehicle-mounted device, for example, a driving computer with wireless communication function or a wireless user equipment with an external driving computer. Or, the user equipment 110 can also be a roadside device, such as a street lamp, a signal lamp or other roadside device with wireless communication function.

The base station 120 may be a network-side device in a wireless communication system. The wireless communication system can be the 4th generation mobile communication (4G) system, also known as long term evolution (LTE) system. Or, the wireless communication system can also be a 5G system (5GS), also known as a new radio (NR) system or a 5G NR system. Or, the wireless communication system can also be a further next-generation system of a 5G system. An access network in the 5G system can be named as a new generation-radio access network (NG-RAN). The base station 120 may be an evolved Node B (eNB) adopted in the 4G system. Or, the base station 120 can also be a next generation Node B (gNB) adopting a centralized and distributed architecture in the 5G system. When the base station 120 adopts a centralized and distributed architecture, it usually includes a central unit (CU) and at least two distributed units (DUs). The centralized unit is provided with a protocol stack of a packet data convergence (PDCP) protocol layer, a radio link Control (RLC) protocol layer and a media access control (MAC) layer, a distributed unit is provided with a protocol stack of a physical (PHY) layer, and the embodiments of the present disclosure do not limit specific implementations of the base station 120.

A wireless connection can be established between the base station 120 and the user equipment 110 through a wireless air interface. In different implementations, the wireless air interface is a wireless air interface based on the 4th generation mobile communication network technology (4G) standard; or the wireless air interface is a wireless air interface based on the 5th generation mobile communication network technology (5G) standard, for example, the wireless air interface is a new radio; or, the wireless air interface can also be a wireless air interface based on a more next generation mobile communication network technology standard based on 5G.

In some embodiments, an end to end (E2E) connection can further be established between the user equipments 110. For example, scenarios of vehicle to vehicle (V2V) communication, vehicle to Infrastructure (V2I) communication and vehicle to pedestrian (V2P) communication in vehicle to everything (V2X) communication.

Here, the above-mentioned user equipment can be considered as a terminal device of the following embodiments.

In some embodiments, the wireless communication system may further include a network management device 130.

Several base stations 120 are respectively connected to a network management device 130. The network management device 130 may be a core network device in a wireless communication system. For example, the network management device 130 may be a mobility management entity (MME) in an evolved packet core (EPC). Or, the network management device can also be other core network devices, such as a serving gateway (SGW), a public data network gateway (PGW), a policy and charging rules function (PCRF) or a home subscriber server (HSS), etc. Embodiments of the present disclosure do not limit the implementation form of the network management device 130.

In order to facilitate the understanding of those skilled in the art, the embodiments of the present disclosure list a plurality of implementations to clearly explain the technical solution of the embodiments of the present disclosure. Of course, those skilled in the art can understand that the multiple embodiments provided in the present disclosure can be executed separately, combined with the methods of other embodiments in the present disclosure, or executed separately or in combination with some methods in other related technologies. Embodiment of that present disclosure do not limit this.

In order to better understand the technical solutions described in any of the embodiments of the present disclosure, firstly, application scenarios in the related technology are described.

In an embodiment, a radar (radio detection and ranging) is a widely used wireless sensing technology that uses radio waves to determine the distance (range), angle, or instantaneous linear velocity of objects. There are other sensing technologies, including non-radio frequency (non-RF) sensors, which have been used in other areas, e.g. time-of-flight (ToF) cameras, accelerometers, gyroscopes and Lidar.

Integrated Sensing and Communication in a 5th generation mobile communication (5G) system means sensing capabilities are provided by a new radio wireless communication system and infrastructure as used for communication, and sensing information could be derived from RF-based and/or non-RF based sensors. In general, it could involve scenarios of communication assisted sensing, e.g. where 5G communication system provides sensing services, or sensing assisted communication, e.g. when sensing information related to a communication channel or environment is used to improve a communication service of the 5G system itself, e.g. the sensing information can be used to assist radio resource management, interference mitigation, beam management, mobility, etc.

In multiple market segments and verticals, the 5G-based sensing services can be beneficial for intelligent transportation, aviation, enterprises, smart cities, smart homes, factories, consumer applications and public sectors.

Mobile operators can play an important role in providing 5GS-based Integrated Sensing and Communication to customers, including, e.g. the management and control of 5G-based sensing service. Examples illustrate operators' role in enhancing V2X type of services, specifically for Infrastructure Assisted Environment Perception, Infrastructure-Based Tele-Operated Driving, High-Definition Map Collecting and Sharing and Tele-Operated Driving Support.

In some embodiments, examples of using 5GS to provide communication assisted sensing services may include the following.

Environment real-time monitoring: Using wireless signals to reconstruct an environment map to further improve positioning accuracy and enable environment related applications, such as realizing an array of real-time monitoring related applications, including dynamic 3D map for driving assistance, pedestrian flow statistics, intrusion detection, traffic detection, etc.

Autonomous vehicles or Unmanned Aerial Vehicle (UAV): Autonomous vehicles or UAV applications have some common functional requirements. For example, Autonomous vehicles or UAV shall support Detect and Avoid (DAA) to avoid obstacles. Meanwhile, Autonomous vehicles or UAV shall have the capability to monitor path information, like selecting routes, complying with traffic regulations.

Air pollution monitoring: The quality of the received wireless signal displays different attenuation characteristics with changes in air humidity, air particulate matter (PM) concentration, carrier frequency and etc., which can be used for weather or air quality detection.

Indoor Health Care and Intrusion Detection: Respiration rate estimation, breathing depth estimation, apnoea detection, elders' vital sign monitoring and indoor intrusion detection can be realized.

In some embodiments, sensing of wireless communication channels and environment could further improve the performance of communication systems. Some examples of sensing assisted communication scenarios include:
sensing a terminal's location and channel environment to narrow a beam sweeping range and shorten a beam training time;
sensing a terminal's location, velocity, motion trajectory, and channel environment for beam prediction, and reducing the overhead of beam measurement and the delay of beam tracking; and
sensing a terminal's property and channel environment to improve the performance of channel estimation.

In an embodiment, referring to FIG. 2, there are different roles in a sensing system.

Reflective object: a target object who's information is sensed.

Transmitter: a device who transmits a radio signal to the target object. It can be a terminal or a base station.

Receiver: a device who detects sensing information based on reflections of the radio signal from the target object. It can be a terminal or a base station.

Initiator: an authorized device which requests from or subscribes to one or multiple receivers for the sensing information. It can be either a terminal, a base station or a network function. It is usually a device which collects the sensing information, and process it to generate a sensing result.

Consumer: consuming an output calculated from sensing information, e.g., it could be UE application, or sensing application server.

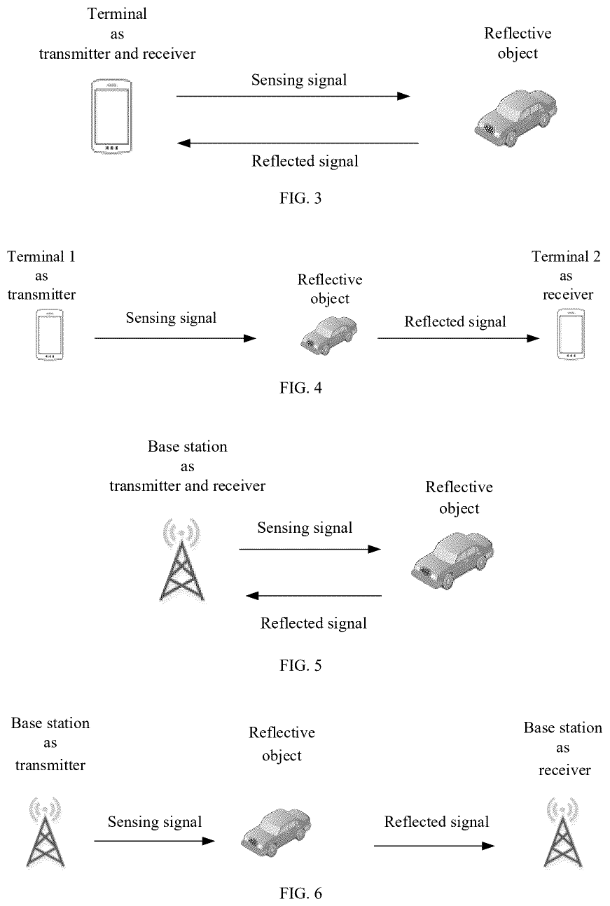

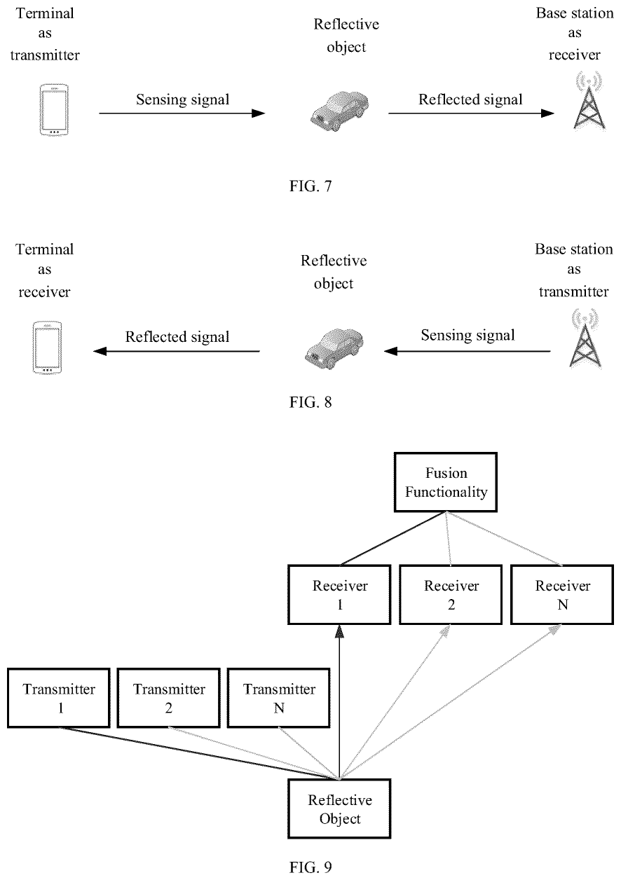

It should be noted that transmitter, receiver, initiator and consumer may be pairwise or all collocated together. Please refer to FIGS. 3 to 8, there are six combinations of whether a terminal or a base station can perform as a transmitter or a receiver in an Integrated Sensing and Communication service.

It should be noted that sensing modes involved in the present disclosure may include: terminal transmitting and terminal receiving, base station transmitting and base station receiving, or mixed receiving and transmitting modes of terminal and base station.

For example, sensing fusion is a process of combining sensing data from disparate sources to derive the sensing result, such that the sensing result has less uncertainty than would be possible when these sources were used individually. Sensing fusion can also be understood as sensory fusion and perceptual fusion, etc., and is not limited here.

Please refer to FIG. 9, which is an overall fusion architecture, in which fusion functionality collects sensing information from multiple receivers.

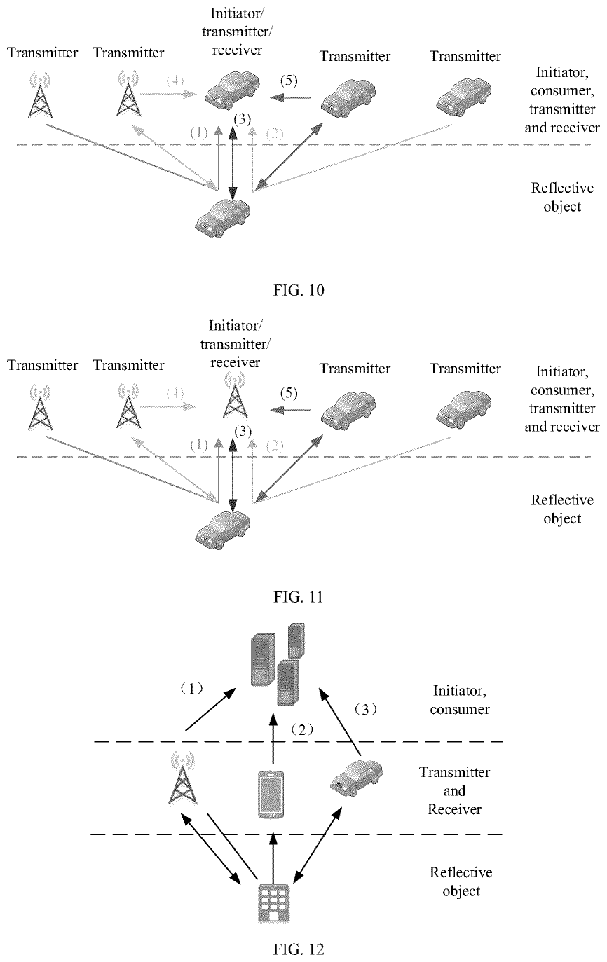

The fusion functionality can be in a terminal, a base station, a network function or an application server. In terms of which entity performs fusing functionality, there can be 4 fusion modes:
terminal-based fusion: a terminal performs fusion functionality, see FIG. 10 for details;
base station-based fusion: a base station performs fusion functionality, see FIG. 11 for details;
network function-based fusion: a network function performs fusion functionality, see FIG. 12 for details; and
application-based fusion: an application server performs fusion functionality, see FIG. 12 for details.

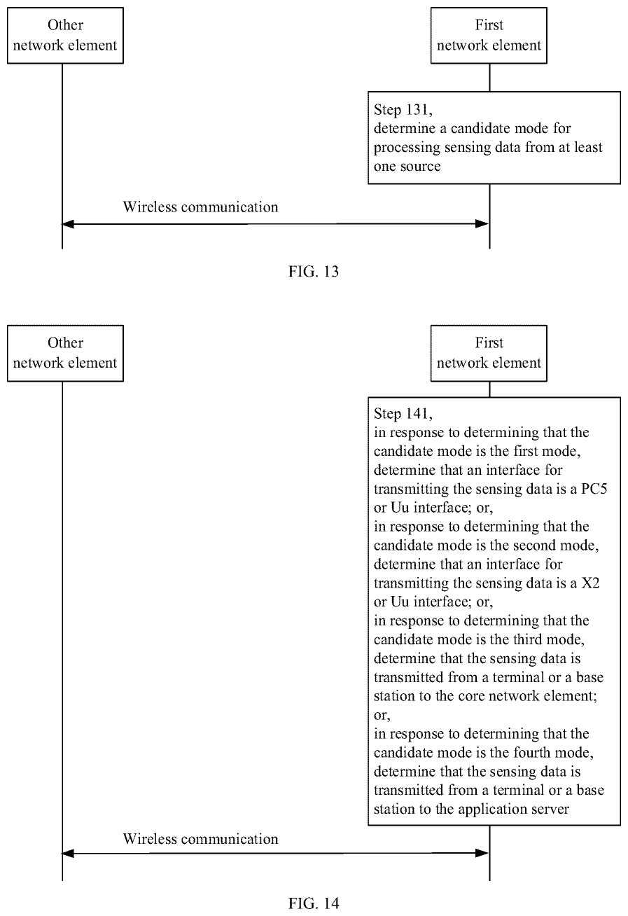

As shown in FIG. 13, a method for processing a sensing service is provided in this embodiment, where the method is performed by a first network element, and the method includes the following step.

At step 131, a candidate mode for processing sensing data from at least one source is determined.

The candidate mode is determined from at least one predetermined sensing data processing mode.

The terminals covered by the present disclosure may be, but are not limited to, a cell phone, a wearable device, an in-vehicle terminal, a road side unit (RSU), a smart home terminal, an industrial sensing device, and/or a medical device, etc. In some embodiments, the terminal may be a Redcap terminal or a new radio (NR) terminal of a predetermined version (e.g., an NR terminal of R17).

The base stations involved in the present disclosure may be various types of base stations, for example, a base station for a third-generation mobile communication (3G) network, a base station for a fourth-generation mobile communication (4G) network, a base station for a fifth-generation mobile communication (5G) network, or other evolved base stations.

The network elements involved in the present disclosure may be an Access and Mobility Management Function (AMF), a Control Plane Sensing Function (SF-C), a Unified Data Management (UDM), and a sensing App, etc. It should be noted that the network element is not limited to the above examples, and it may be any network element with a sensing function (SF). In some embodiments of the present disclosure, the network element with sensing function can be deployed as a communication node alone or in an existing network element. In a word, the network element with SF can be understood as a logical node that can be flexibly deployed in a network, and it is not limited here.

In an embodiment, the first network element may be an SF-C.

In an embodiment, a candidate mode for performing fusion processing on the sensing data from at least one source is determined, where the candidate mode is determined from predetermined sensing data processing mode(s).

In an embodiment, a candidate mode for processing sensing data from at least one source is determined from predetermined sensing data processing mode(s). The predetermined sensing data processing mode includes at least one of:
a first mode for processing the sensing data based on a terminal;
a second mode for processing the sensing data based on a base station;
a third mode for processing the sensing data based on a core network element; or
a fourth mode for processing the sensing data based on an application server. The above modes can be further subdivided according to different receivers and/or transmitters, and are not limited here. Fusion of sensing data may also be named as sensing data fusion, as a type of sensing data processing, but it should be noted that sensing data processing is not limited to sensing data fusion, but may also be any other scenario-specific processing of sensing data.

It should be noted that the sensing data processing may be: a process of combining sensing data from at least one source to obtain a sensing result, such that the sensing result has less uncertainty than would be possible when these sources were used individually, and/or, analyzing and/or calculating the sensing data to derive a sensing result.

It should be noted that the third mode and the fourth mode can also be collectively named as a mode of processing sensing data based on a network.

It should be noted that the sensing data from at least one source may be sensing data acquired by at least one receiver, where the receiver may be a terminal and/or a base station.

In an embodiment, a candidate mode for processing sensing data acquired by at least one receiver is determined, where the candidate mode is determined from predetermined sensing data processing mode(s). The sensing data processing is performed based on the candidate mode.

In an embodiment, a candidate mode for processing sensing data from at least one source is determined according to a predetermined rule, where the candidate mode is determined from predetermined sensing data processing mode(s).

In an embodiment, the predetermined rule may be: determining a candidate mode for processing the sensing data from the at least one source according to a priority order of each mode in the predetermined sensing data processing modes. For example, if the priority order of the predetermined sensing data processing modes is: the first mode, the second mode, the third mode and the fourth mode, the first network element will preferentially determine the candidate mode for processing sensing data from at least one source as the first mode. It should be noted that if the execution of the sensing data processing using the first mode fails, a predetermined sensing data processing mode with a lower priority is determined in accordance with the priority order to process the sensing data from the at least one source, e.g., the sensing data from at least one source will be processed in the second mode.

In an embodiment, the predetermined rule may also be: randomly determining a candidate mode for processing sensing data from at least one source. For example, a mode randomly selected from the first mode, the second mode, the third mode and the fourth mode is determined as the candidate mode for processing sensing data from at least one source, and as an example, the first mode is randomly determined as the candidate mode. It should be noted that if the execution of the sensing data processing using the first mode fails, another predetermined sensing data processing mode will be selected in a random manner to process the sensing data from at least one source.

In an embodiment, the predetermined rule can also be: determine the candidate mode for processing sensing data from at least one source according to predetermined information. The predetermined information may be at least one of the following:
service authorization information of a terminal or a base station;
user consent information;
information about capability and/or current state of a terminal, a base station, or a core network; information about the current state includes current load information of the terminal, the base station or the core network;
sensing service request information; or
information about a pre-configured operator allowed sensing data processing mode.

In an embodiment, only when the service authorization information indicates that the terminal is authorized to perform sensing data processing, the first network element may determine the candidate mode as the first mode.

In an embodiment, only when the service authorization information indicates that the base station is authorized to perform sensing data processing, the first network element may determine the candidate mode as the second mode.

In an embodiment, only when the user consent information indicates a willingness of the terminal to be a transmitter or a receiver, the first network element may determine the candidate mode as a sensing data processing mode with the terminal as the transmitter or the receiver.

In an embodiment, only when the predetermined information indicates that the terminal, the base station or the core network element has a qualified capability and/or load, the first network element may determine a candidate mode for the corresponding terminal, the base station or the core network element.

In an embodiment, the sensing service request may directly indicate the candidate mode; for example, it may directly indicate that the first mode is taken as the candidate mode.

In an embodiment, the information about the pre-configured operator allowed sensing data processing mode directly indicates the candidate mode.|[syy1]

In an embodiment, in response to the service authorization information of the terminal indicating that a predetermined terminal is authorized to execute the sensing data processing, it is determined that the predetermined terminal can be an executing subject for performing the sensing data processing, and the candidate mode for processing sensing data from at least one source is determined as the first mode, where a terminal performing the sensing data processing based on the first mode is the predetermined terminal.

In an embodiment, in response to the service authorization information of the base station indicating that a predetermined base station is authorized to execute the sensing data processing, it is determined that the predetermined base station can be an executing subject for performing the sensing data processing, and the candidate mode for processing sensing data from at least one source is determined as the second mode, where a base station performing the sensing data processing based on the second mode is the predetermined base station.

In an embodiment, the user consent information indicates that the predetermined terminal is allowed to be a transmitter and/or a receiver, it is determined that the predetermined terminal can be a transmitter and/or a receiver, and the candidate mode for processing sensing data from at least one source is determined, where a transmitter and/or receiver corresponding to the candidate mode is the predetermined terminal.

In an embodiment, the capability and/or load information of the terminal indicates that a capability of the predetermined terminal is capable of performing sensing data processing, it is determined that the predetermined terminal can be an executing subject for performing the sensing data processing, and the candidate mode for processing sensing data from at least one source is determined as the first mode, where a terminal performing the sensing data processing based on the first mode is the predetermined terminal. Or, the capability and/or load information of the terminal indicates that a load of the predetermined terminal is capable of performing sensing data processing, it is determined that the predetermined terminal can be an executing subject for performing the sensing data processing, and the candidate mode for processing sensing data from at least one source is determined as the first mode, where a terminal performing the sensing data processing based on the first mode is the predetermined terminal.

In an embodiment, the capability and/or load information of the base station indicates that a capability of the predetermined base station is capable of performing sensing data processing, it is determined that the predetermined base station can be an executing subject for performing the sensing data processing, and the candidate mode for processing sensing data from at least one source is determined as the second mode, where a base station performing the sensing data processing based on the second mode is the predetermined base station. Or, the capability and/or load information of the base station indicates that a load of the predetermined base station is capable of performing sensing data processing, it is determined that the predetermined base station can be an executing subject for performing the sensing data processing, and the candidate mode for processing sensing data from at least one source is determined as the second mode, where a base station performing the sensing data processing based on the second mode is the predetermined base station.

In an embodiment, the capability and/or load information of the core network element indicates that a capability of a predetermined core network element is capable of performing sensing data processing, it is determined that the predetermined core network element can be an executing subject for performing the sensing data processing, and the candidate mode for processing sensing data from at least one source is determined as the third mode, where a core network element performing the sensing data processing based on the third mode is the predetermined core network element. Or, the capability and/or load information of the core network element indicates that a load of a predetermined core network element is capable of performing sensing data processing, it is determined that the predetermined core network element can be an executing subject for performing the sensing data processing, and the candidate mode for processing sensing data from at least one source is determined as the third mode, where a core network element performing the sensing data processing based on the third mode is the predetermined core network element.

In an embodiment, the sensing service request information is a multi-sensing information request. The multi-sensing information request indicates that the predetermined terminal is capable of performing sensing data processing and can be an executing subject for performing the sensing data processing, and thus the candidate mode for processing sensing data from at least one source is determined as the first mode, where a terminal performing the sensing data processing based on the first mode is the predetermined terminal.

In an embodiment, the sensing service request information is the multi-sensing information request. The multi-sensing information request indicates that a predetermined application server is capable of performing sensing data processing and can be an executing subject for performing the sensing data processing, and thus the candidate mode for processing sensing data from at least one source is determined as the fourth mode, where an application server performing the sensing data processing based on the fourth mode is the predetermined application server.

In an embodiment, the sensing service request information is a direct indication of data processing request. The direct indication of data processing request indicates that a predetermined subject can perform sensing data processing and can be an executing subject for performing sensing data processing, and thus the candidate mode for processing sensing data from at least one source is a mode determined based on the predetermined subject, where an executing subject performing the sensing data processing in the mode is the predetermined subject.

In an embodiment, the sensing service request information is a high QoS sensing result request. According to the requirement of requesting QoS sensing result indicated by the high Qos sensing result request, it is determined that the predetermined subject can be an executing subject for performing sensing data processing, and the candidate mode for processing sensing data from at least one source is a mode determined based on the predetermined subject, where an executing subject performing the sensing data processing in the mode is the predetermined subject.

In an embodiment, the sensing service request information is sensing data processing mode preference information. According to a predetermined sensing data processing mode indicated by the sensing data processing mode preference information, the candidate mode for processing sensing data from at least one source is determined. For example, the candidate mode is the predetermined sensing data processing mode.

In an embodiment, the sensing service request information is the information about the pre-configured operator allowed sensing data processing mode. According to a predetermined sensing data processing mode indicated by the information about the pre-configured operator allowed sensing data processing mode, the candidate mode for processing sensing data from at least one source is determined. For example, the candidate mode is the predetermined sensing data processing mode.

In the embodiments of the present disclosure, the candidate mode for processing the sensing data from the at least one source is determined, where the candidate mode is determined from at least one predetermined sensing data processing mode. The first network element can determine a candidate mode for processing the sensing data from the at least one source from the at least one predetermined sensing data processing mode, so that the sensing data processing can be performed based on the candidate mode, which provides a coordination mechanism for an application of sensing data processing technology in the network, and makes the coordination between the network and sensing data technology more efficient and reliable compared with the situation that the network cannot determine the candidate mode.

It should be noted that those skilled in the art can understand that the methods provided by the embodiments of the present disclosure can be executed alone or together with some methods in the embodiments of the present disclosure or some methods in related technologies.

In an embodiment, the predetermined sensing data processing mode includes at least one of the following:
a first mode for processing the sensing data based on a terminal;
a second mode for processing the sensing data based on a base station;
a third mode for processing the sensing data based on a core network element; or
a fourth mode for processing the sensing data based on an application server.

As shown in FIG. 14, a method for processing a sensing service is provided in this embodiment, where the method is performed by a first network element, and the method includes the following step.

At step 141, in response to determining that the candidate mode is the first mode, it is determined that an interface for transmitting the sensing data is a |PC5 or Uu| [BT2]|[BT3]|[BT4]|[syy5] interface;
or,
in response to determining that the candidate mode is the second mode, it is determined that an interface for transmitting the sensing data is a |X2 or Uu|[BT6]|BT[7] interface;

or,
in response to determining that the candidate mode is the third mode, it is determined that the sensing data is transmitted from a terminal or a base station to the core network element;
or,
in response to determining that the candidate mode is the fourth mode, it is determined that the sensing data is transmitted from a terminal or a base station to the application server.

In an embodiment, a candidate mode for processing the sensing data from at least one source is determined, where the candidate mode is determined from predetermined sensing data processing mode(s). In response to determining that the candidate mode is the first mode, it is determined that an interface for transmitting the sensing data is a PC5 or Uu interface.

In an embodiment, a candidate mode for processing the sensing data from at least one source is determined, where the candidate mode is determined from predetermined sensing data processing mode(s). In response to determining that the candidate mode is the second mode, it is determined that an interface for transmitting the sensing data is a X2 or Uu interface.

In an embodiment, a candidate mode for processing the sensing data from at least one source is determined, where the candidate mode is determined from predetermined sensing data processing mode(s). In response to determining that the candidate mode is the third mode, it is determined that the sensing data is transmitted from a terminal or a base station to the core network element.

In an embodiment, a candidate mode for processing the sensing data from at least one source is determined, where the candidate mode is determined from predetermined sensing data processing mode(s). in response to determining that the candidate mode is the fourth mode, it is determined that the sensing data is transmitted from a terminal or a base station to the application server.

It should be noted that those skilled in the art can understand that the methods provided by the embodiments of the present disclosure can be executed alone or together with some methods in the embodiments of the present disclosure or some methods in related technologies.

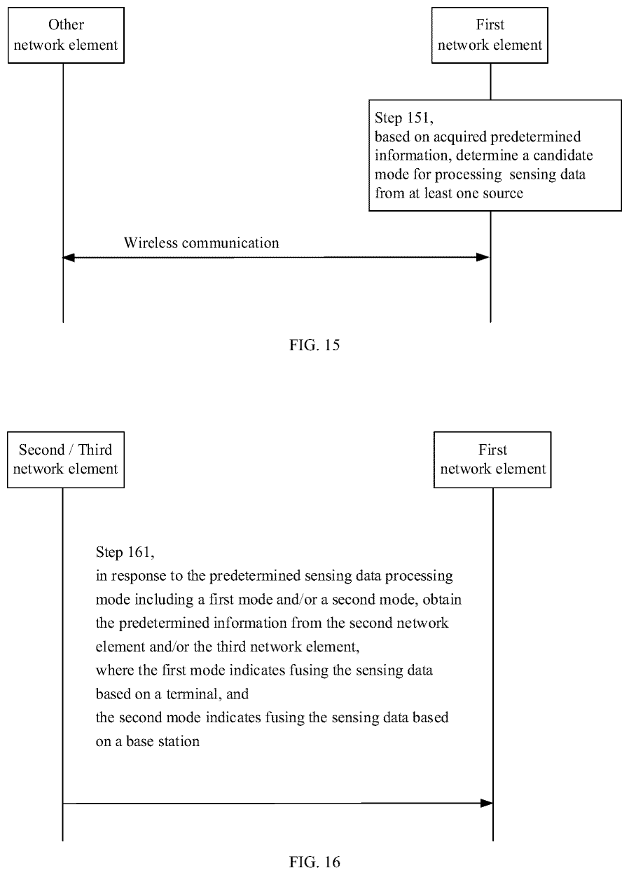

As shown in FIG. 15, a method for processing a sensing service is provided in this embodiment, where the method is performed by a first network element, and the method includes the following step.

At step 151, based on acquired predetermined information, a candidate mode for processing sensing data from at least one source is determined.

In an embodiment, the predetermined information includes at least one of the following:
service authorization information of a terminal or a base station;
user consent information;
information about capability and/or current state of a terminal, a base station, or a core network;
sensing service request information; or
information about a pre-configured operator allowed sensing data processing mode.

In an embodiment, the information about capability and/or current state of the terminal is stored as part of terminal subscription data in a UDM.

In an embodiment, the information about capability and/or current state of the terminal is stored as part of terminal context in an AMF.

In an embodiment, the first network element may acquire the information about capability and/or current state of the terminal from the UDM or AMF.

In an embodiment, the service authorization information of the terminal and/or the sensing service request information is stored as part of terminal subscription data in the UDM.

In an embodiment, the information about capability of the base station can be acquired from the AMF. In an embodiment, the AMF acquires the information about capability of the base station during an N2 node layer process.

In an embodiment, the first network element pre-configures the capability of the core network element.

It should be noted that those skilled in the art can understand that the methods provided by the embodiments of the present disclosure can be executed alone or together with some methods in the embodiments of the present disclosure or some methods in related technologies.

As shown in FIG. 16, a method for processing a sensing service is provided in this embodiment, where the method is performed by a first network element, and the method includes the following step.

At step 161, in response to the predetermined sensing data processing mode including a first mode and/or a second mode, obtain the predetermined information from the second network element and/or the third network element;

where the first mode is a mode for processing the sensing data based on a terminal, and the second mode is a mode for processing the sensing data based on a base station.

In an embodiment, the first network element is SF-C, and the second network element is AMF.

In an embodiment, the predetermined information is obtained from the second network element in response to the predetermined sensing data processing mode, which includes the first mode and/or the second mode. A candidate mode for processing the sensing data from at least one source is determined according to the predetermined information, where the candidate mode is determined from predetermined sensing data processing mode(s).

In an embodiment, the predetermined information is obtained from the third network element in response to the predetermined sensing data processing mode including the first mode and/or the second mode. A candidate mode for processing the sensing data from at least one source is determined according to the predetermined information, where the candidate mode is determined from predetermined sensing data processing mode(s).

It should be noted that those skilled in the art can understand that the methods provided by the embodiments of the present disclosure can be executed alone or together with some methods in the embodiments of the present disclosure or some methods in related technologies.

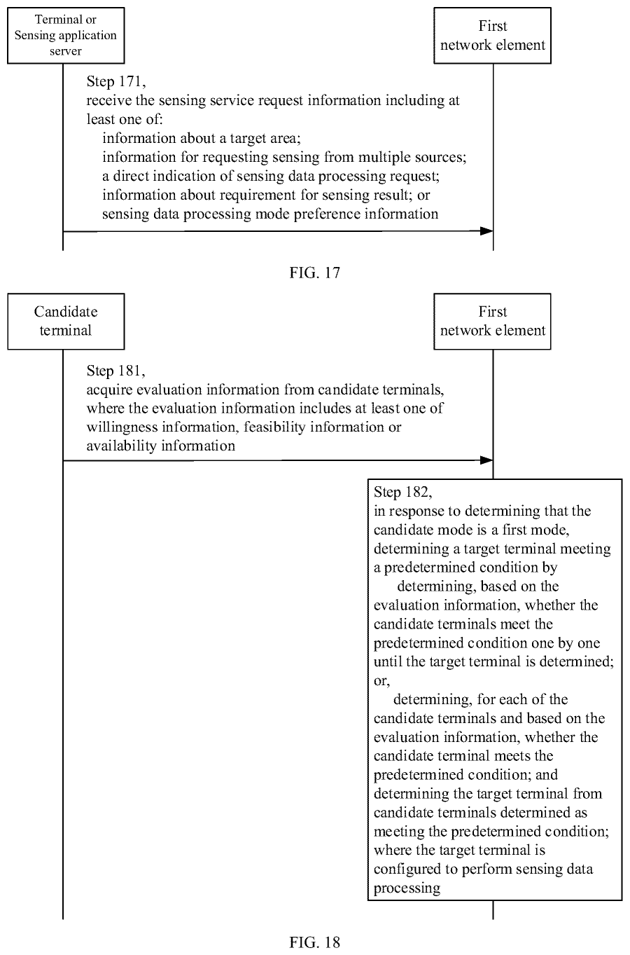

As shown in FIG. 17, a method for processing a sensing service is provided in this embodiment, where the method is performed by a first network element, and the method includes the following step.

At step 171, sensing service request information is received, where the sensing service request information includes at least one of:
information about a target area;
information for requesting sensing from multiple sources;
a direct indication of sensing data processing request;
information about requirement for sensing result; or
sensing data processing mode preference information.

In some embodiments, it may be to receive the sensing service request information from a terminal or a sensing application server.

In an embodiment, after acquiring the information about the target area, list information of terminals and/or base stations in the target area indicated by the information about the target area can be acquired. An alternative terminal for performing sensing data processing or an alternative transmitter and/or receiver for performing sensing data processing may be determined based on the list information.

For the description of step 171, please refer to the description of step 131, which is not repeated here.

It should be noted that those skilled in the art can understand that the methods provided by the embodiments of the present disclosure can be executed alone or together with some methods in the embodiments of the present disclosure or some methods in related technologies.

As shown in FIG. 18, a method for processing a sensing service is provided in this embodiment, where the method is performed by a first network element, and the method includes the following steps.

At step 181, evaluation information is acquired from candidate terminals, where the evaluation information includes at least one of: willingness information, feasibility information or availability information.

At step 182, in response to determining that the candidate mode is a first mode, determining a target terminal meeting a predetermined condition by: determining, based on the evaluation information, whether the candidate terminals meet the predetermined condition one by one until the target terminal is determined; or, determining, for each of the candidate terminals and based on the evaluation information, whether the candidate terminal meets the predetermined condition; and determining the target terminal from candidate terminals determined as meeting the predetermined condition, where the target terminal is configured to perform sensing data processing.

In an embodiment, a candidate mode for processing the sensing data from at least one source is determined, where the candidate mode is determined from predetermined sensing data processing mode(s). The evaluation information is acquired from the candidate terminals. The evaluation information includes at least one of the following: willingness information, feasibility information or availability information. In response to determining that the candidate mode is the first mode, based on the evaluation information, it is determined whether the candidate terminals meet the predetermined condition one by one until a target terminal meeting the predetermined condition is determined. The target terminal is determined from the candidate terminals meeting the predetermined condition, and the target terminal is configured to perform sensing data processing.

In an embodiment, a candidate mode for processing the sensing data from at least one source is determined, where the candidate mode is determined from predetermined sensing data processing mode(s). The evaluation information is acquired from the candidate terminals. The evaluation information includes at least one of the following: willingness information, feasibility information or availability information. In response to determining that the candidate mode is the first mode, for each of the candidate terminals and based on the evaluation information, it is determined whether the candidate terminal meets the predetermined condition. The target terminal is determined from candidate terminals determined as meeting the predetermined condition among all the candidate terminals. The target terminal is configured to perform sensing data processing.

It should be noted that those skilled in the art can understand that the methods provided by the embodiments of the present disclosure can be executed alone or together with some methods in the embodiments of the present disclosure or some methods in related technologies.

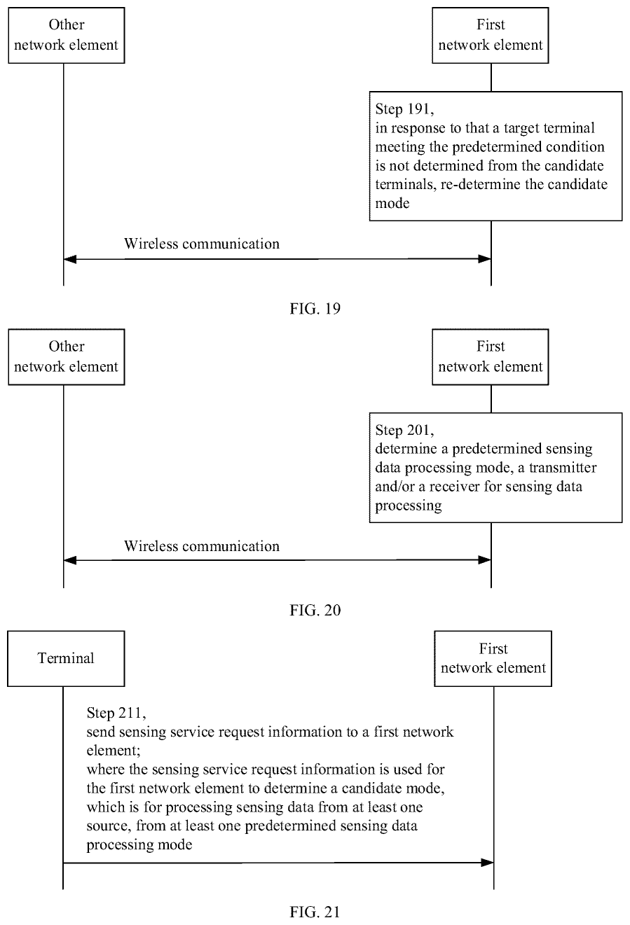

As shown in FIG. 19, a method for processing a sensing service is provided in this embodiment, where the method is performed by a first network element, and the method includes the following step.

At step 191, in response to that the target terminal meeting the predetermined condition is not determined from the candidate terminals, the candidate mode is re-determined.

In an embodiment, a candidate mode for processing the sensing data from at least one source is determined, where the candidate mode is determined from predetermined sensing data processing mode(s). In response to the candidate mode being the first mode and the target terminal meeting the predetermined condition is not determined from the candidate terminals, the candidate mode is re-determined. The re-determined candidate mode may be one of the second mode, the third mode and the fourth mode.

It should be noted that those skilled in the art can understand that the methods provided by the embodiments of the present disclosure can be executed alone or together with some methods in the embodiments of the present disclosure or some methods in related technologies.

As shown in FIG. 20, a method for processing a sensing service is provided in this embodiment, where the method is performed by a first network element, and the method includes the following step.

At step 201, a predetermined sensing mode, a transmitter and/or a receiver of the sensing service are determined.

In an embodiment, the predetermined sensing mode, transmitter and/or receiver of the sensing service are determined according to predetermined information. The predetermined information includes at least one of the following:
service authorization information of a terminal or a base station;
user consent information;
information about capability and current state of a terminal, a base station, or a core network;
sensing service request information; or
information about a pre-configured operator allowed sensing data processing mode.

It should be noted that those skilled in the art can understand that the methods provided by the embodiments of the present disclosure can be executed alone or together with some methods in the embodiments of the present disclosure or some methods in related technologies.

As shown in FIG. 21, a method for processing a sensing service is provided in this embodiment, where the method is performed by a terminal, and the method includes the following step.

At step 211, sensing service request information is sent to a first network element;
where the sensing service request information is used for the first network element to determine a candidate mode, which is for processing sensing data from at least one source, from at least one predetermined sensing data processing mode.

In an embodiment, the predetermined sensing data processing mode includes at least one of the following:
a first mode for processing the sensing data based on a terminal;
a second mode for processing the sensing data based on a base station;
a third mode for processing the sensing data based on a core network element; or
a fourth mode for processing the sensing data based on an application server.

In an embodiment, the sensing service request information includes at least one of the following:
information about a target area;
information for requesting sensing from multiple sources;
a direct indication of sensing data processing request;
information about requirement for sensing result; or
sensing data processing mode preference information.

In an embodiment, the sensing service request information is a multi-sensing information request. The multi-sensing information request indicates that a predetermined terminal is capable of performing sensing data processing and can be an executing subject for performing the sensing data processing, and thus the candidate mode for processing sensing data from at least one source is determined as the first mode, where a terminal performing the sensing data processing in the first mode is the predetermined terminal.

In an embodiment, the sensing service request information is the multi-sensing information request. The multi-sensing information request indicates that a predetermined application server is capable of performing sensing data processing and can be an executing subject for performing the sensing data processing, and thus the candidate mode for processing sensing data from at least one source is determined as the fourth mode, where an application server performing the sensing data processing in the fourth mode is the predetermined application server.

In an embodiment, the sensing service request information is the direct indication of sensing data processing request. The direct indication of sensing data processing request indicates that a predetermined subject can perform sensing data processing and can be an executing subject for performing sensing data processing, and thus the candidate mode for processing sensing data from at least one source is a mode determined based on the predetermined subject, where an executing subject performing the sensing data processing in the mode is the predetermined subject.

In an embodiment, the sensing service request information is a high QoS sensing result request. According to the requirement of requesting a QoS sensing result indicated by the high QoS sensing result request, it is determined that the predetermined subject can be an executing subject for performing sensing data processing, and the candidate mode for processing sensing data from at least one source is a mode determined based on the predetermined subject, where an executing subject performing the sensing data processing in the mode is the predetermined subject.

In an embodiment, the sensing service request information is the sensing data processing mode preference information. According to a predetermined sensing data processing mode indicated by the sensing data processing mode preference information, the candidate mode for processing sensing data from at least one source is determined. For example, the candidate mode is the predetermined sensing data processing mode.

In an embodiment, the sensing service request information is the information about the pre-configured operator allowed sensing data processing mode. According to a predetermined sensing data processing mode indicated by the information about the pre-configured operator allowed sensing data processing mode, the candidate mode for processing sensing data from at least one source is determined. For example, the candidate mode is the predetermined sensing data processing mode.

It should be noted that those skilled in the art can understand that the methods provided by the embodiments of the present disclosure can be executed alone or together with some methods in the embodiments of the present disclosure or some methods in related technologies.

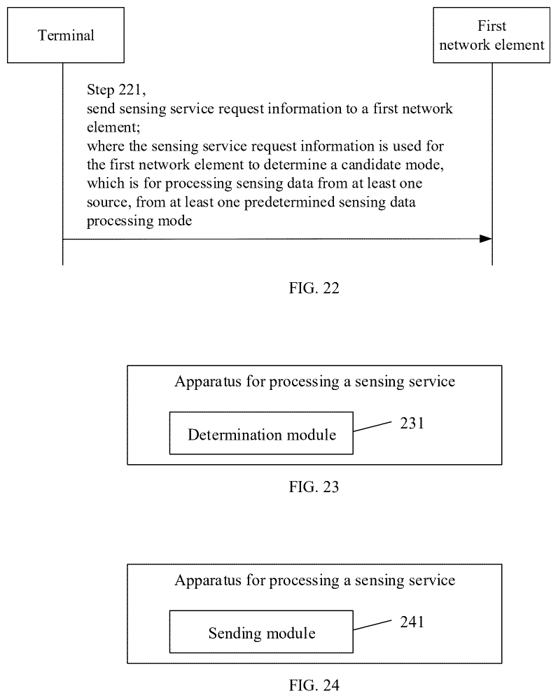

As shown in FIG. 22, a method for processing a sensing service is provided in this embodiment, where the method is performed by a fourth network element, and the method includes the following step.

At step 221, sensing service request information is sent to a first network element;
where the sensing service request information is used for the first network element to determine a candidate mode, which is for processing sensing data from at least one source, from at least one predetermined sensing data processing mode.

The fourth network element can be a sensing application server.

In an embodiment, the predetermined sensing data processing mode includes at least one of the following:
a first mode for processing the sensing data based on a terminal;
a second mode for processing the sensing data based on a base station;
a third mode for processing the sensing data based on a core network element; or
a fourth mode for processing the sensing data based on an application server.

In an embodiment, the sensing service request information includes at least one of the following:
information about a target area;
information for requesting sensing from multiple sources;
a direct indication of sensing data processing request;
information about requirement for sensing result; or
sensing data processing mode preference information.

In an embodiment, the sensing service request information is a multi-sensing information request. The multi-sensing information request indicates that a predetermined terminal is capable of performing sensing data processing and can be an executing subject for performing the sensing data processing, and thus the candidate mode for processing sensing data from at least one source is determined as the first mode, where a terminal performing the sensing data processing in the first mode is the predetermined terminal.

In an embodiment, the sensing service request information is the multi-sensing information request. The multi-sensing information request indicates that a predetermined application server is capable of performing sensing data processing and can be an executing subject for performing the sensing data processing, and thus the candidate mode for processing sensing data from at least one source is determined as the fourth mode, where an application server performing the sensing data processing in the fourth mode is the predetermined application server.

In an embodiment, the sensing service request information is the direct indication of sensing data processing request. The direct indication of sensing data processing request indicates that a predetermined subject can perform sensing data processing and can be an executing subject for performing sensing data processing, and thus the candidate mode for processing sensing data from at least one source is a mode determined based on the predetermined subject, where an executing subject performing the sensing data processing in the mode is the predetermined subject.

In an embodiment, the sensing service request information is a high QoS sensing result request. According to the requirement of requesting a QoS sensing result indicated by the high QOS sensing result request, it is determined that the predetermined subject can be an executing subject for performing sensing data processing, and the candidate mode for processing sensing data from at least one source is a mode determined based on the predetermined subject, where an executing subject performing the sensing data processing in the mode is the predetermined subject.

In an embodiment, the sensing service request information is the sensing data processing mode preference information. According to a predetermined sensing data the sensing data processing mode preference information, the candidate mode for processing sensing data from at least one source is determined. For example, the candidate mode is the predetermined sensing data processing mode.

In an embodiment, the sensing service request information is the information about the pre-configured operator allowed sensing data processing mode. According to a predetermined sensing data processing mode indicated by the information about the pre-configured operator allowed sensing data processing mode, the candidate mode for processing sensing data from at least one source is determined. For example, the candidate mode is the predetermined sensing data processing mode.

It should be noted that those skilled in the art can understand that the methods provided by the embodiments of the present disclosure can be executed alone or together with some methods in the embodiments of the present disclosure or some methods in related technologies.

As shown in FIG. 23, an embodiment of the present disclosure provides an apparatus for processing a sensing service, including:

a determination module 231, configured to determine a candidate mode for processing sensing data from at least one source;

where the candidate mode is determined from at least one predetermined sensing data processing mode.

It should be noted that those skilled in the art can understand that the methods provided by the embodiments of the present disclosure can be executed alone or together with some methods in the embodiments of the present disclosure or some methods in related technologies.

As shown in FIG. 24, an embodiment of the present disclosure provides an apparatus for processing a sensing service, including:

a sending module 241, configured to send sensing service request information to a first network element;

where the sensing service request information is used for the first network element to determine a candidate mode, which is for processing sensing data from at least one source, from at least one predetermined sensing data processing mode.

It should be noted that those skilled in the art can understand that the methods provided by the embodiments of the present disclosure can be executed alone or together with some methods in the embodiments of the present disclosure or some methods in related technologies.

In order to better understand the embodiments of the present disclosure, the technical solution of the present disclosure will be further explained through three exemplary embodiments.

### Example 1

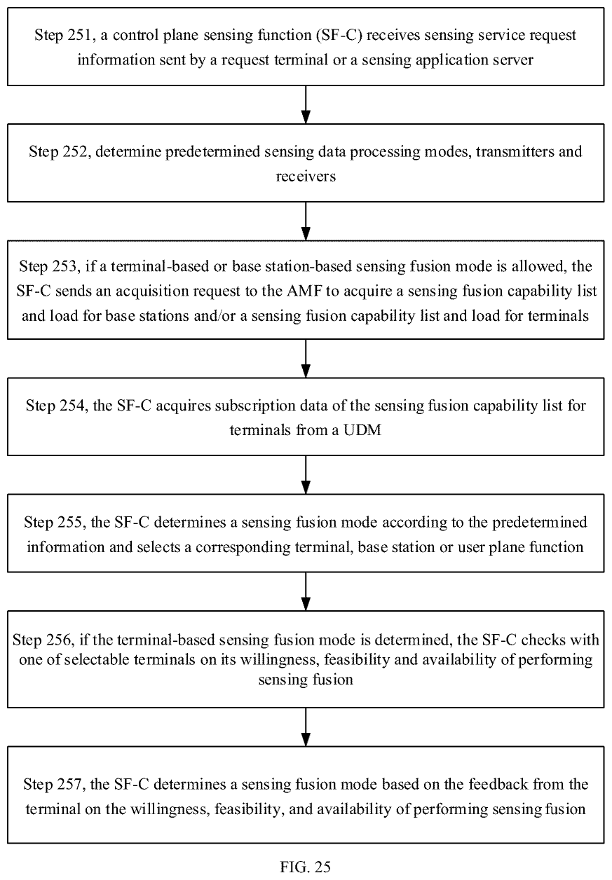

Please refer to FIG. 25, which provides a method for processing a sensing service, including the following steps.

At step 251, a control plane sensing function (SF-C) receives sensing service request information sent by a request terminal or a sensing application server. It should be noted that the control plane sensing function can send a response message to the request terminal or the sensing application server after receiving the sensing service request information. The sensing service request information includes at least one of the following:
information about a target area;
information for requesting sensing from multiple sources;
a direct indication of sensing data processing request;
information about requirement for sensing result; or
sensing data processing mode preference information.

At step 252, predetermined sensing data processing modes, transmitters and receivers are determined. It should be noted that in step 252, list information of terminals and/or base stations in the target area indicated by the information about the target area can be acquired (for example, acquired by AMF or UDM). This list information is used to determine the transmitters and receivers.

At step 253, if a terminal-based or base station-based sensing data processing mode is allowed, the SF-C sends an acquisition request to the AMF to acquire a sensing data processing capability list and load for base stations, and/or, sends an acquisition request to the AMF to acquire a sensing data processing capability list and load for terminals. It should be noted that the load and list in step 253 can also be acquired in the acquisition process in step 252, which is not limited here.

At step 254, the SF-C acquires subscription data of the sensing data processing capability list for terminals from a UDM. It should be noted that the subscription data acquired in step 254 can also be acquired in the acquisition process in step 252 or step 253, which is not limited here.

At step 255, the SF-C determines a sensing data processing mode according to the predetermined information and selects a corresponding terminal, base station or user plane function. The predetermined information includes at least one of the following:
service authorization information of a terminal or a base station;
user consent information;
information about capability and load of a terminal, a base station, or a core network;
sensing data processing request information; or
information about a pre-configured operator allowed sensing data processing mode.

At step 256, if the terminal-based sensing data processing mode is determined, the SF-C checks with one of selectable terminals on its willingness, feasibility and availability of performing sensing data processing.

At step 257, the SF-C determines a sensing data processing mode based on feedback from the terminal on the willingness, feasibility, and availability of performing sensing data processing. If the candidate terminal cannot perform sensing data processing, the SF-C will select another terminal from the optional terminals to check the willingness, feasibility and availability of performing sensing data processing.

### Example 2

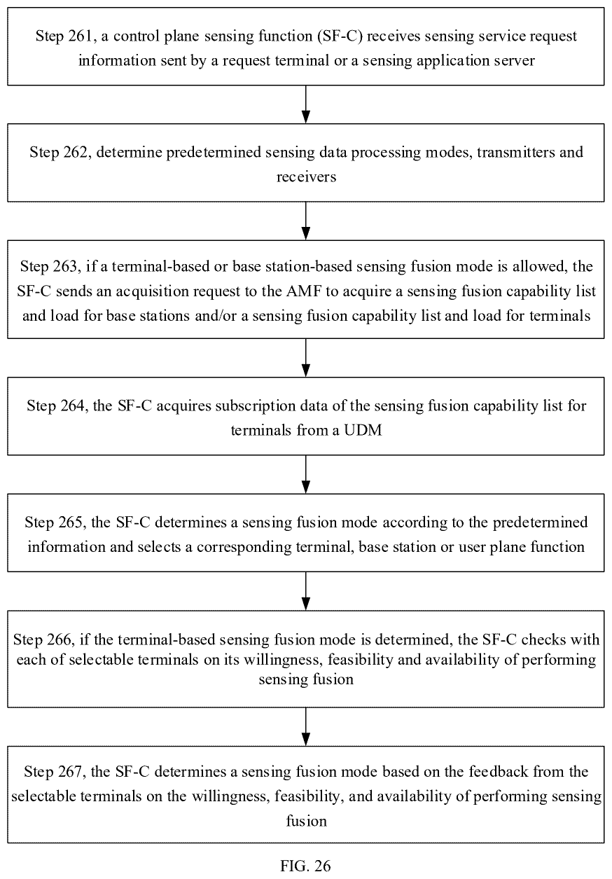

Please refer to FIG. 26, which provides a method for processing a sensing service, including the following steps.

At step 261, a control plane sensing function (SF-C) receives sensing service request information sent by a request terminal or a sensing application server. It should be noted that the control plane sensing function can send a response message to the request terminal or the sensing application server after receiving the sensing service request information. The sensing service request information includes at least one of the following:
information about a target area;
information for requesting sensing from multiple sources;
a direct indication of sensing data processing request;
information about requirement for sensing result; or
sensing data processing mode preference information.

At step 262, predetermined sensing data processing modes, transmitters and receivers are determined. It should be noted that in step 262, list information of terminals and/or base stations in the target area indicated by the information about the target area can be acquired (for example, acquired by AMF or UDM). This list information is used to determine the transmitters and receivers.

At step 263, if a terminal-based or base station-based sensing data processing mode is allowed, the SF-C sends an acquisition request to the AMF to acquire a sensing data processing capability list and load for base stations, and/or, sends an acquisition request to the AMF to acquire a sensing data processing capability list and load for terminals. It should be noted that the load and list in step 263 can also be acquired in the acquisition process in step 262, which is not limited here.

At step 264, the SF-C acquires subscription data of the sensing data processing capability list for terminals from the UDM. It should be noted that the subscription data acquired in step 264 can also be acquired in the acquisition process in step 262 or step 263, which is not limited here.

At step 265, the SF-C determines a sensing data processing mode according to the predetermined information and selects a corresponding terminal, base station or user plane function. The predetermined information includes at least one of the following:
service authorization information of a terminal or a base station;
user consent information;
information about capability and load of a terminal, a base station, or a core network;
sensing service request information; or
information about a pre-configured operator allowed sensing data processing mode.

At step 266, if the terminal-based sensing data processing mode is determined, the SF-C checks with each of the selectable terminals on its willingness, feasibility and availability of performing sensing data processing.

At step 267, the SF-C determines a sensing data processing mode based on feedback from the selectable terminals on the willingness, feasibility, and availability of performing sensing data processing.

### Example 3

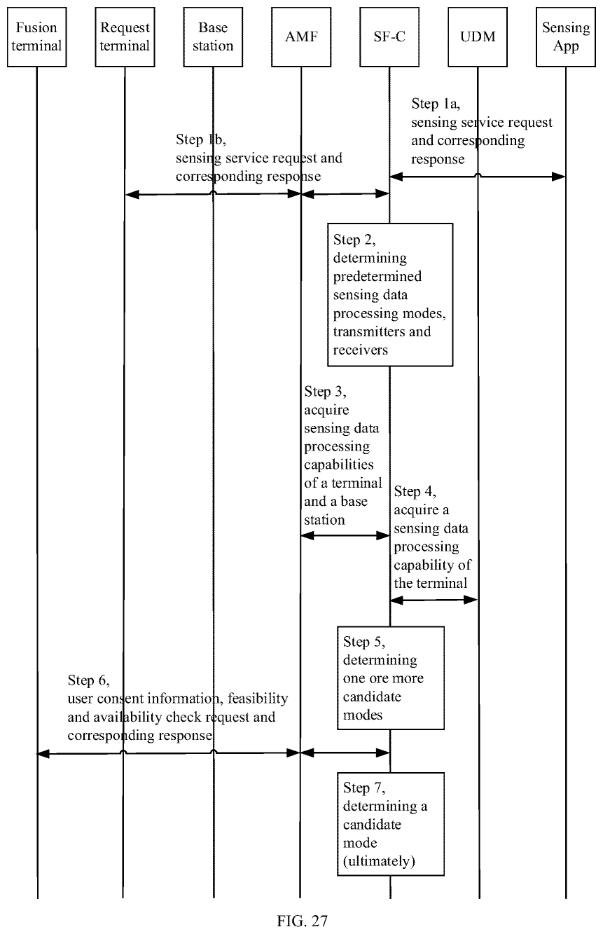

Please refer to FIG. 27, which is a schematic diagram of a method for processing a sensing service, including:
at step 1 (including steps 1a and 1b), sensing service request and corresponding response;
at step 2, predetermined sensing data processing modes, transmitters and receivers are determined;
at step 3, sensing data processing capabilities of a terminal and a base station are acquired;
at step 4, a sensing data processing capability of the terminal is acquired;
at step 5, one or more candidate sensing data processing modes are determined;
at step 6, user consent information, feasibility and availability check request and corresponding response; and
at step 7, a candidate sensing data processing mode (a sensing data processing mode ultimately used) is determined.

An embodiment of the present disclosure provides a communication device, including: a processor; and
a memory, configured to store processor-executable instructions;
where the processor is configured to implement the method applied to any embodiment of the present disclosure when executing the executable instructions.

The processor may include various types of storage media that are non-transitory computer storage media capable of continuing to memorize the information stored thereon after the communication device is powered down.

The processor may be connected memory via a bus, etc., for reading an executable program stored on the memory.

An embodiment of the present disclosure further provides a computer storage medium, where the computer storage medium stores a computer executable program, and the executable program, when executed by a processor, realizes the method of any embodiment of the present disclosure.

Regarding to the apparatus in the above embodiment, a specific way in which each module performs operations has been described in detail in the embodiments relating to the method, and will not be described in detail here.

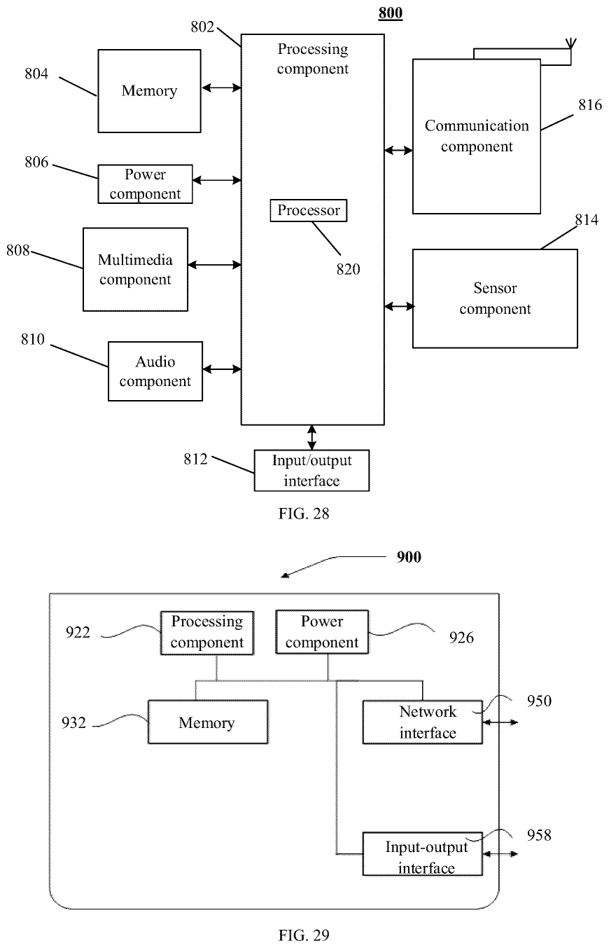

As shown in FIG. 28, an embodiment of the present disclosure provides a structure of a terminal.

Referring to FIG. 28, this embodiment provides a terminal 800, which can be a mobile phone, a computer, a digital broadcasting terminal, a messaging device, a game console, a tablet device, a medical device, a fitness device, a personal digital assistant, etc.

Referring to FIG. 28, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls an overall operation of the terminal 800, such as operations associated with display, telephone call, data communication, camera operation and recording operation. The processing component 802 may include one or more processors 820 to execute instructions to complete all or part of steps of the above-mentioned method. In addition, the processing component 802 may include one or more modules to facilitate interactions between the processing component 802 and other components. For example, the processing component 802 may include a multimedia module to facilitate interactions between the multimedia component 808 and the processing component 802.

The memory 804 is configured to store various types of data to support operations in the terminal 800. Examples of these data include instructions of any application program or method for being operated on the terminal 800, contact data, phone book data, messages, pictures, videos, etc. The memory 804 can be implemented by any type of volatile or non-volatile memory device or combinations thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 806 provides power to various components of the terminal 800. The power component 806 may include a power management system, one or more power supplies, and other components associated with generating, managing and distributing power for the terminal 800.

The multimedia component 808 includes a screen that provides an output interface between the terminal 800 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touching, sliding and gestures on the touch panel. The touch sensor may not only sense a boundary of a touching or sliding action, but also detect a duration and a pressure related to the touching or sliding operation. In some embodiments, the multimedia component 808 includes a front camera and/or a rear camera. When the terminal 800 is in an operation mode, such as a shooting mode or a video mode, the front camera and/or the rear camera can receive external multimedia data. Each front camera and rear camera may be a fixed optical lens system or have focal length and optical zoom capability.

The audio component 810 is configured to output and/or input audio signals. For example, the audio component 810 includes a microphone (MIC) configured to receive external audio signals when the terminal 800 is in the operation mode, such as a calling mode, a recording mode and a voice recognition mode. The received audio signal may be further stored in the memory 804 or transmitted via the communication component 816. In some embodiments, the audio component 810 further includes a speaker for outputting audio signals.

The I/O interface 812 provides an interface between the processing component 802 and peripheral interface modules, where the peripheral interface modules may be keyboards, click-wheels, buttons, etc. These buttons may include, but are not limited to: home button, volume button, start button and lock button.

The sensor component 814 includes one or more sensors for providing various aspects of state evaluation for the terminal 800. For example, the sensor component 814 can detect an on/off state of the terminal 800, a relative positioning of components, for example, the components are the display and the keypad of the terminal 800, and the sensor component 814 can further detect a position change of the terminal 800 or a component of the terminal 800, presence or absence of user contact with the terminal 800, orientation or acceleration/deceleration of the terminal 800 and a temperature change of the terminal 800. The sensor component 814 may include a proximity sensor configured to detect presence of a nearby object without any physical contact. The sensor component 814 may also include an optical sensor, such as a CMOS or CCD image sensor, for use in imaging applications. In some embodiments, the sensor component 814 may further include an acceleration sensor, a gyroscope sensor, a magnetic sensor, a pressure sensor or a temperature sensor.

The communication component 816 is configured to facilitate wired or wireless communication between the terminal 800 and other devices. The terminal 800 can access a wireless network based on communication standards, such as WiFi, 2G or 3G, or combinations thereof. In an embodiment of the present disclosure, the communication component 816 receives a broadcast signal or broadcast related information from an external broadcast management system via a broadcast channel. In an embodiment of the present disclosure, the communication component 816 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment of the present disclosure, the terminal 800 may be implemented by one or more application-specific integrated circuits (ASIC), digital signal processors (DSP), digital signal processing devices (DSPD), programmable logic devices (PLD), field programmable gate arrays (FPGA), controllers, micro-controllers, micro-processors or other electronic components, for executing the above-mentioned method.

In an embodiment of the present disclosure, a non-transitory computer-readable storage medium including instructions is further provided, such as the memory 804 including instructions, where the instructions can be executed by the processor 820 of the terminal 800 to complete the above-mentioned method. For example, the non-transitory computer-readable storage medium may be an ROM, a random access memory (RAM), a CD-ROM, a magnetic tape, a floppy disk, an optical data storage device, etc.

As shown in FIG. 29, an embodiment of the present disclosure shows a structure of a base station. For example, the base station 900 can be provided as a network-side device. Referring to FIG. 29, the base station 900 includes a processing component 922, which further includes one or more processors, and memory resources represented by a memory 932 for storing instructions that can be executed by the processing component 922, such as application programs. An application program stored in the memory 932 may include one or more modules each corresponding to a set of instructions. In addition, the processing component 922 is configured to execute instructions to perform any of the aforementioned methods applied to the base station.

The base station 900 may further include a power component 926 configured to perform power management of the base station 900, a wired or wireless network interface 950 configured to connect the base station 900 to a network, and an input-output (I/O) interface 958. The base station 900 can operate based on an operating system stored in the memory 932, such as Windows Server™, Mac OS X™, Unix™, Linux™, FreeBSD™ or the like.

Other embodiments of the present disclosure will easily occur to those skilled in the art after considering the specification and practicing the present disclosure disclosed herein. The present disclosure is intended to cover any variations, uses or adaptations of the present disclosure, and these variations, uses or adaptations follow general principles of the present disclosure and include common sense or common technical means in the technical field that are not disclosed in the present disclosure. The specification and embodiments are to be regarded as exemplary only, and true scope and spirit of the present disclosure are indicated by the following claims.

It should be understood that the present disclosure is not limited to precise structures described above and shown in the accompanying drawings, and various modifications and changes can be made without departing from its scope. The scope of the present disclosure is limited only by the appended claims.

1. A method for processing a sensing service, performed by a first network element and comprising:
determining a candidate mode for processing sensing data from at least one source;
wherein the candidate mode is determined from at least one predetermined sensing data processing mode.

2. The method according to claim 1, wherein the at least one predetermined sensing data processing mode comprises at least one of:
a first mode for processing the sensing data based on a terminal;
a second mode for processing the sensing data based on a base station;
a third mode for processing the sensing data based on a core network element; or
a fourth mode for processing the sensing data based on an application server.

3. The method according to claim 2, further comprising:
in response to determining that the candidate mode is the first mode, determining that an interface for transmitting the sensing data is a PC5 or Uu interface; or,
in response to determining that the candidate mode is the second mode, determining that an interface for transmitting the sensing data is a X2 or Uu interface; or,
in response to determining that the candidate mode is the third mode, determining that the sensing data is transmitted from the terminal or the base station to the core network element; or,
in response to determining that the candidate mode is the fourth mode, determining that the sensing data is transmitted from the terminal or the base station to the application server.

4. The method according to claim 1, wherein the determining the candidate mode for the processing sensing data from the at least one source comprises:
determining, based on acquired predetermined information, the candidate mode for processing the sensing data from the at least one source.

5. The method according to claim 4, wherein the acquired predetermined information comprises at least one of:
service authorization information of a terminal or a base station;
user consent information;
information about at least one of capability or current state of the terminal, the base station, or a core network;
sensing service request information; or
information about a pre-configured operator allowed sensing data processing mode.

6. The method according to claim 5, further comprising:
in response to that the at least one predetermined sensing data processing mode comprises at least one of a first mode or a second mode, obtaining the acquired predetermined information from at least one of a second network element or a third network element,
wherein the first mode is a mode for processing the sensing data based on the terminal, and the second mode is a mode for processing the sensing data based on the base station.

7. The method according to claim 5, further comprising:
receiving the sensing service request information,
wherein the sensing service request information comprises at least one of:
information about a target area;
information for requesting sensing from multiple sources;
a direct indication of sensing data processing request;
information about requirement for sensing result; or
sensing data processing mode preference information.

8. The method according to claim 1, further comprising:
acquiring evaluation information from candidate terminals, wherein the evaluation information comprises at least one of willingness information, feasibility information or availability information;
in response to determining that the candidate mode is a first mode, determining a target terminal meeting a predetermined condition by:
determining, based on the evaluation information, whether the candidate terminals meet the predetermined condition one by one until the target terminal is determined; or,
determining, based on the evaluation information, candidate terminals meeting the predetermined condition; and determining the target terminal from the candidate terminals meeting the predetermined condition;
wherein the target terminal is configured to perform sensing data processing.

9. The method according to claim 8, further comprising:
in response to that the target terminal meeting the predetermined condition is not determined from the candidate terminals, re-determining the candidate mode.

10. The method according to claim 1, further comprising:
determining at least one of a predetermined sensing mode, a transmitter or a receiver of the sensing service.

11. A method for processing a sensing service, performed by a terminal and comprising:
sending sensing service request information to a first network element;
wherein the sensing service request information is used for the first network element to determine a candidate mode, which is for processing sensing data from at least one source, from at least one predetermined sensing data processing mode.

12. The method according to claim 11, wherein the at least one predetermined sensing data processing mode comprises at least one of:
a first mode for processing the sensing data based on the terminal;
a second mode for processing the sensing data based on a base station;
a third mode for processing the sensing data based on a core network element; or
a fourth mode for processing the sensing data based on an application server.

13. The method according to claim 11, wherein the sensing service request information comprises at least one of:
information about a target area;
information for requesting sensing from multiple sources;
a direct indication of sensing data processing request;
information about requirement for sensing result; or
sensing data processing mode preference information.

14. A method for processing a sensing service, performed by a fourth network element and comprising:
sending sensing service request information to a first network element;
wherein the sensing service request information is used for the first network element to determine a candidate mode, which is for processing sensing data from at least one source, from at least one predetermined sensing data processing mode.

15. The method according to claim 14, wherein the at least one predetermined sensing data processing mode comprises at least one of:
a first mode for processing the sensing data based on a terminal;
a second mode for processing the sensing data based on a base station;
a third mode for processing the sensing data based on a core network element; or
a fourth mode for processing the sensing data based on an application server.

16. The method according to claim 14, wherein the sensing service request information comprises at least one of:
information about a target area;
information for requesting sensing from multiple sources;
a direct indication of sensing data processing request;
information about requirement for sensing result; or
sensing data processing mode preference information.

17-18. (canceled)

19. A communication device, comprising:
a memory; and
a processor, connected to the memory, configured to execute computer-executable instructions stored on the memory and capable of implementing the method according to claim 1.

20. A non-transitory computer storage medium, the non-transitory computer storage medium storing computer-executable instructions, the computer-executable instructions, when executed by a processor cause the processor to perform the method according to claim 1.

21. A communication device, comprising:
a memory; and
one or more processors connected to the memory and configured to execute computer-executable instructions stored on the memory, wherein the computer-executable instructions when executed by the one or more processors cause the one or more processor to collectively perform the method according to claim 11.

22. A communication device, comprising:
a memory; and
one or more processors connected to the memory and configured to execute computer-executable instructions stored on the memory,
wherein the computer-executable instructions when executed by the one or more processors cause the one or more processors to collectively perform the method according to claim 14.
